(19) United States
(12) Patent Application Publication
(10) Pub. No.: US 2023/0314645 A1
(43) Pub. Date: Oct. 5, 2023

(54) SEISMIC IMAGING RESOLUTION ANALYSIS METHOD AND DEVICE AND MEMORY MEDIUM

(71) Applicant: CHINA UNIVERSITY OF PETROLEUM (East China), Qingdao (CN)

(72) Inventors: Liyun FU, Qingdao (CN); Zhiwei WANG, Qingdao (CN); Wei WEI, Qingdao (CN); Qizhen DU, Qingdao (CN); Qingqing LI, Qingdao (CN)

(73) Assignee: CHINA UNIVERSITY OF PETROLEUM (East China), Qingdao (CN)

(21) Appl. No.: 17/726,178

(22) Filed: Apr. 21, 2022

(30) Foreign Application Priority Data
Mar. 31, 2022 (CN) 202210332045.3

(51) Int. Cl. G01V 1/30

(52) U.S. Cl. CPC G01V 1/303; G01V 2210/74; G01V 2210/6222

(57) ABSTRACT

The seismic imaging resolution analysis method comprises: obtaining common-shot gathers and common-detector gathers; in the common-shot gathers, conducting detector focusing analysis on a focus point at (xⱼ, zₙ) in each source point gather to obtain a source point focal-beam gather; looping all the focus points at a depth zₙ, and conducting computation on a weighted source-focusing operator Pᵢₖ^{†} (zₙ, zₙ); in the common-detector gathers, conducting source point focusing analysis on an focus point at (xⱼ, zₙ) in each source point gather to obtain a detector focal-beam gather; Loop all the focus points at a depth zₙ, and conducting computation on a weighted detector-focusing operator Pᵢₖ (zₙ, zₙ); and conducting computation on a normalized resolution function of a single focus point so as to obtain a horizontal resolution and a definition.

### CROSS-REFERENCE TO RELATED APPLICATIONS

The application claims priority to Chinese patent application No. 202210332045.3, filed on Mar. 31, 2022, the entire contents of which are incorporated herein by reference.

### TECHNICAL FIELD

The present invention relates to the technical field of seismic imaging resolution analysis, in particular to a seismic imaging resolution analysis method and device and a memory medium.

### BACKGROUND

Three-dimensional seismic exploration is a major means for oil and gas exploration; and the underground structural features can be obtained only when processing data for seismic acquisition is imaged. Therefore, the selection of a seismic imaging method is crucial to the imaging quality.

Prestack seismic migration imaging has already become a mainstream technology in the industry. However, for the reasons of band-limited data, limited imaging apertures, spatial sampling, complex structures and the like, prestack seismic migration imaging is limited to imaging resolution, and it is a challenging task of assessing the effectiveness of a single factor on imaging. Existing resolution analysis with a point spread function and traditional focusing analysis are both based on the response of a single-point scatterer, with ignoring the effect of surrounding points, and are generally applied to an acquisition observation system without being suitable for imaging data. In addition, for existing prestack seismic migration imaging, resolution analysis based on a wave equation is huge in computational cost and low in computational efficiency. Therefore, it requires a better auxiliary tool to measure the resolution performance for seismic imaging.

### SUMMARY

An objective of the present invention is to provide a seismic imaging resolution analysis method and device and a memory medium, so as to solve the above problems in the Background.

In order to achieve the above objective, the present invention provides the following technical solution:

A seismic imaging resolution analysis method, comprising:
obtaining common-shot gathers and common-detector gathers;
in the common-shot gathers, conducting detector focusing analysis on an focus point at (xⱼ, zₙ) in each source paint gather to obtain a source point focal-beam gather;
loop all the focus points at a depth zₙ, and conducting computation on a weighted source-focusing operator Pᵢₖ^{†} (zₙ, zₙ);
in the common-detector gathers, conducting source point focusing analysis on a focus point at (xⱼ, zₙ) in each source point gather to obtain a detector focal-beam gather;
loop all the focus points at the depth zₙ, and conducting computation on a weighted detector-focusing operator Pᵢₖ (zₙ, zₙ); and
conducting computation on a normalized resolution function of a single focus point so as to obtain a horizontal resolution and a definition;
in which xⱼ represents the jₜₕ point on the abscissa, and zₙ represents a depth of a target reflector.

Further, by giving the depth of the target reflector and an initial computational frequency and inputting a single-frequency common-shot gather and a single-frequency common-detector gather at the same time, computation is conducted to obtain a detector focusing result and a source point focusing result of the focus points, and the results are put at the source point positions and the detector positions respectively.

Further, the weighted source-focusing operator Pᵢₖ^{†} (zₙ, zₙ) is calculated through a formula 2, and the formula 2 is as follows: Pᵢₖ^{†}(zₙ, zₙ)=Fᵢ^{†}(zₙ, z₀)P(z₀, z₀)Fₖ(z₀, zₙ)+ε(z), (z≠zₙ);
the weighted detector-focusing operator is calculated through a formula 3, and the formula 3 is as follows: Pᵢₖ(zₙ,zₙ)=Fₖ(zₙ,z₀)P(z₀, z₀)Fᵢ(z₀,zₙ)+ε(z), (z≠zₙ);
in which z₀ is a depth of a detector; P(z₀,z₀) represents information, received from the ground and reflected from a subsurface interface, of a wavefield; k locally varies at the periphery of a focus point (xᵢ, zₙ); Fₖ (z₀, zₙ) and Fᵢ (z₀, zₙ) are detector-focusing operator at the depth 4; and Fₖ (zₙ, z₀) and Fᵢ (zₙ, z₀) are source-point focusing operators at z₀.

Further, the information, received from the ground and reflected from the subsurface interface, of the wavefield is as follows:

P(z₀,z₀)=D(z₀)Σₙ₌₁^{N}[W(z₀,zₙ)R(zₙ,zₙ)W(zₙ,z₀)]S(z₀),

D (z₀) is a detector matrix, containing information, received by the detectors, of arrangement of seismic wavelets and detectors. S (z₀) is a source point matrix, containing arrangement information of source wavelets and a seismic source. W (z₀, zₙ) is an upgoing wave propagation matrix; and when in a uniform medium, each row is a discrete Green function matrix, representing that the wavefield is propagated from the depth zₙ to the depth zₙ upward. W (zₙ, z₀) is a downgoing wave propagation matrix; and when in the uniform medium, each column is a discrete Green function matrix, representing that the wavefield is propagated from the depth z₀ to the depth zₙ downward. R (zₙ, zₙ) is a reflection coefficient matrix, representing reflection and scattering relationships between a subsurface reflection point and an adjacent point.

Further, a resolution function is calculated by a formula 4, and the formula 4 is as follows: Bᵢₖ(zₙ, zₙ)=\sqrt{Pᵢₖ(zₙ,zₙ)⊗Pᵢₖ^{\}(zₙ,zₙ)}, in which ⊗ represents multiplication of elements.

In order to achieve the above objective, the present invention further provides the following technical solution:

Disclosed is a seismic imaging resolution analysis device, comprising:
an obtaining unit for obtaining common-shot gathers and common-detector gathers;
a detector focusing analysis unit for, in the common-shot gathers, conducting detector focusing analysis on a focus point at (xⱼ, zₙ) in each source point gather to obtain a source point focal-beam gather,
a source-focusing operator weight computation section for looping all the focus points at a depth xₙ and conducting computation on a weighted source-focusing operator Pᵢₖ^{†} (zₙ, zₙ);
a source point focusing analysis unit for, in the common-detector gathers, conducting source point focusing analysis on an focus point at (xⱼ, xₙ) in each source point gather to obtain a detector focal-beam gather;
a detector-focusing operator weight computation section for looping all the focus points at the depth zₙ and conducting computation on a weighted detector-focusing operator Pᵢₖ (zₙ, zₙ); and
a computation and analysis unit for conducting computation on a normalized resolution function of a single focus point so as to obtain a horizontal resolution and a definition;
in which xⱼ represents the jₜₕ point on the abscissa, and zₙ represents a depth of a target reflector.

In order to achieve the above objective, the present invention further provides the following technical solution:
Disclosed is computer equipment, comprising: a memory and a processor. Computer programs are stored on the memory; and when the computer programs are executed by a processor, a step in any of the above methods is performed.

In order to achieve the above objective, the present invention further provides the following technical solution:
Disclosed is a computer-readable storage medium, on which computer programs are stored. When the computer programs are executed by a processor, a step in any of the above methods is performed.

Compared with the prior art, the present invention has the beneficial effects that:
The present invention employs the above technical solutions and has the following advantages that: (1) existing resolution analysis with a point spread function and a traditional focusing analysis method are both based on response of a single-point scatterer with ignoring the effect of surrounding points; whereas a weighted focal-beam resolution analysis method proposed by this patent may conduct detector focusing and source point focusing through the common-shot gathers and the common-detector gathers respectively, and response of a given scatterer is recognized from the combined effect of a plurality of scatterers. (2) Focal-beam resolution analysis and prestack seismic migration are achieved together without additional computational cost and share same wavefield extrapolation, which is an economic and effective method for quantifying the performance of seismic imaging. (3) The horizontal resolutions and the definitions of seismic imaging data may be quantified. The present invention may be widely applied to the field of imaging technologies for seismic oil exploration.

### BRIEF DESCRIPTION OF DRAWINGS

FIG. 1 is a flow chart of a specific method according to an embodiment of the present invention.

FIG. 2 is a diagram of a five-layer velocity model.

FIG. 3 is a curve diagram of a seismic resolution function.

FIG. 4 shows curve diagrams of horizontal resolutions (a) and definitions (b) at different interfaces.

FIG. 5 is a cross section of a prestack seismic migration image.

FIG. 6 is a flow chart of a method according to the present invention.

FIG. 7 is a block diagram of a device according to the present invention.

FIG. 8 is an interior structural diagram of computer equipment according to the present invention.

### DETAILED DESCRIPTION OF THE EMBODIMENTS

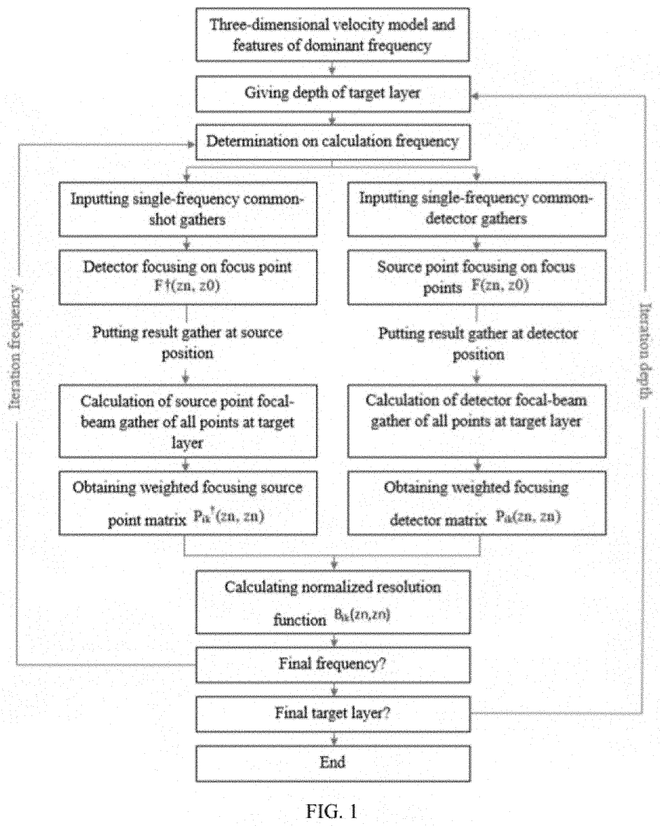

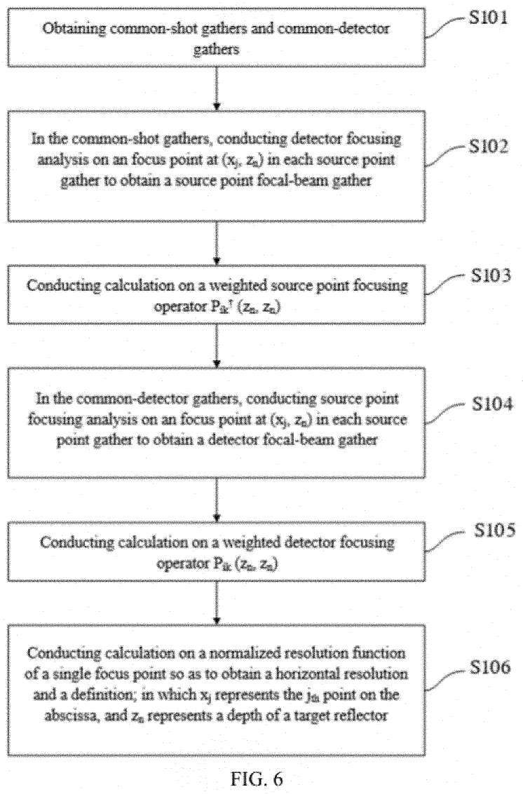

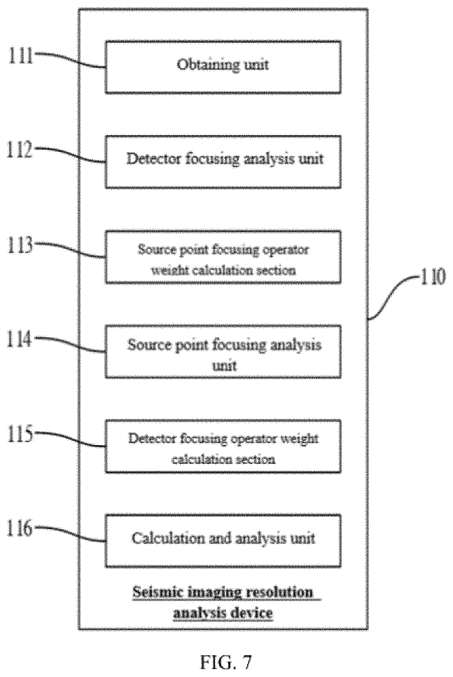

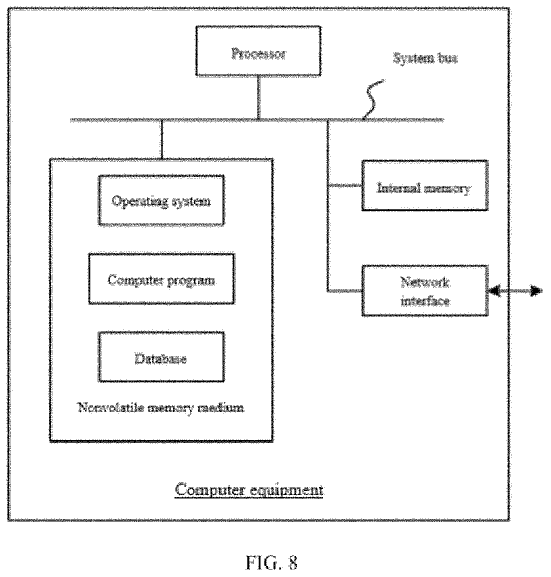

Referring to FIGS. 1-8, the present invention provides a technical solution:

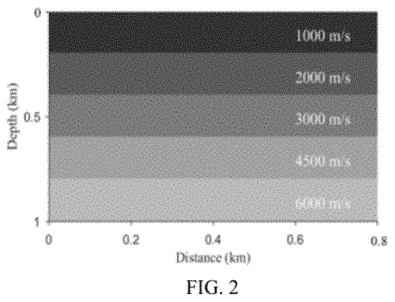

A seismic imaging resolution analysis method includes the following steps:
1) In common-shot gathers, detector focusing analysis is conducted on an focus point at (xⱼ, zₙ) in each source point gather.
2) The step 1 is repeated for all the focus points at a depth zₙ to obtain a source point focal-beam gather.
3) Loop all the focus points at the depth zₙ, and computation is conducted on a weighted source-focusing operator Pᵢₖ^{†} (zₙ, zₙ) through a formula 2.
4) In common-detector gathers, source point focusing analysis is conducted on the focus point at (xⱼ, zₙ) in each source point gather.
5) The step 4 is repeated for all the focus points at the depth zₙ to obtain a detector focal-beam gather.
6) Loop all the focus points at the depth zₙ, and computation is conducted on a weighted detector-focusing operator Pᵢₖ (zₙ, zₙ) through a formula 3.
7) Computation is conducted on a normalized resolution function of a single focus point by applying a formula 4 so as to obtain a horizontal resolution and a definition.
8) With a model as an example, an imaging principle is applied to complete focal-beam migration. The correctness of a weighted focal-beam resolution analysis method proposed by the method of the present invention is verified from a seismic migration imaging result. The model is shown in FIG. 2, which is a velocity made, with five layers of 200 m per layer, velocities of various layers are different, and the details are shown with respect to icons.

Involved Formulas

Information, received from the ground and reflected from the subsurface interface, of a wavefield:

P(z₀,z₀)=D(z₀)Σₙ₌₁^{N}[W(z₀,zₙ)R(zₙ,zₙ)W(zₙ,z₀)]S(z₀), (1)

zₙ is a depth of a target reflector, and z₀ is a depth of a detector. D (z₀) is a detector matrix, containing information, received by the detectors, of arrangement of seismic wavelets and detectors. S (z₀) is a source point matrix, containing arrangement information of source wavelets and a seismic source. W (z₀, zₙ) is an upgoing wave propagation matrix; and when in a uniform medium, each row is a discrete Green function matrix, representing that the wavefield is propagated from the depth zₙ to the depth z₀ upward, W (zₙ, z₀) is a downgoing wave propagation matrix; and when in the uniform medium, each column is a discrete Green function matrix, representing that the wavefield is propagated from the depth z₀ to the depth zₙ downward, R (zₙ, zₙ) is a reflection coefficient matrix, representing reflection and scattering relationships between a subsurface reflection point and an adjacent point. Multiplication of the focusing operators and the detector matrix is detector focusing analysis, and multiplication of the focusing operators and the source point matrix is source point focusing analysis.

In the step 3), the weighted source-focusing operator is calculated through a formula 2:

Pᵢₖ^{†}(zₙ,zₙ)=Fᵢ^{†}(zₙ,z₀)P(z₀,z₀)Fₖ(z₀,zₙ)+ε(x),(z≠zₙ), (2)

In the step 6), the weighted detector-focusing operator is calculated through a formula 3:

Pᵢₖ(zₙ,zₙ)=Fₖ(zₙ,z₀)P(z₀,z₀)Fᵢ(z₀,zₙ)+ε(z),(z≠zₙ), (3)
in which k locally varies at the periphery of a focus (xᵢ, zₙ); Fₖ (z₀, zₙ) and Fᵢ (z₀, zₙ) are detector-focusing operator at the depth zₙ; Fₖ (z₀, zₙ) and Fᵢ (z₀, zₙ) are source-focusing operators at z₀; and ε (z) is migration noise.

In the step 7), a resolution function is calculated through a formula 4:

Bᵢₖ(zₙ,zₙ)=\sqrt{Pᵢₖ(zₙ,zₙ)⊗Pᵢₖ^{†}(z₀,zₙ)}, (4)

in which ⊗ represents multiplication of elements.

In the step 8), the seismic migration imaging process is the process of conducting detector focusing and source point focusing on information of the wavefield; and therefore, a seismic migration imaging result may be obtained directly through a focal-beam method.

z₀ is the depth of the target reflector, and z is an ordinate. In the present invention, z₀ is the depth of the target reflector, i.e. the position with the depth of 0, which is the ground, zₙ is the position with the depth of n, representing a reflector. The depth of the target reflector is from Om to nm; and as shown in FIG. 2, N represents 5 and is the number of layers, and i and k represent the transverse and longitudinal positions respectively. In the figure, the abscissa represents a distance of 800 m transversely, and the ordinate represents a depth of 1000 m longitudinally.

In the present invention, the focal-beam analysis method belongs to the prior art, specifically referring focal-beam analysis (Berkhout, et al., 2001; Volker, et al., 2001, 2002) which is a method of applying the prestack depth migration theory to evaluation on a design solution of a three-dimensional seismic acquisition observation system. The basic thought of the method is as follows: wavefield continuation and focusing computation are conducted on detectors and source points respectively to obtain a detector focusing matrix and a source point focusing matrix.

The present invention will be described below in detail in combination with the accompanying drawings and the embodiments.

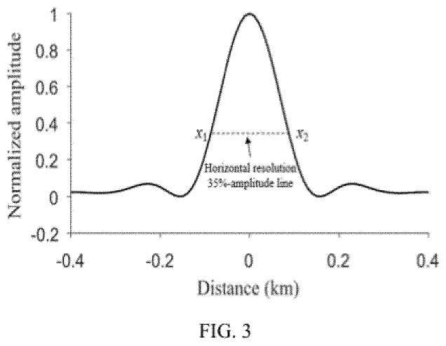

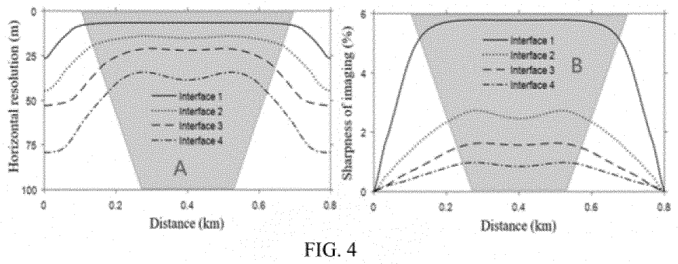

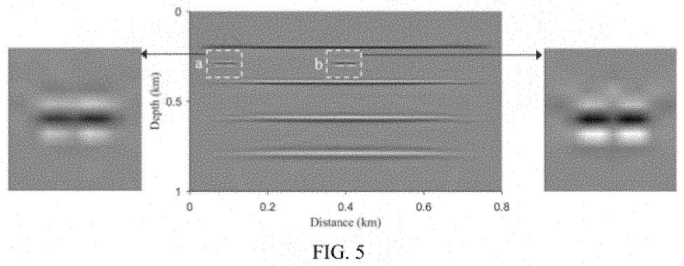

As shown in FIG. 1, the present invention discloses a seismic imaging resolution analysis method, comprising the following steps:
1) aiming to a subsurface target position, a three-dimensional velocity model and features of a dominant frequency are combined. In this case, provided is the five-layer velocity model with a horizontal length of 800 m and a depth of 1000 m, and velocities of various layers are 1000 m/s, 2000 m/s, 3000 m/s, 4500 m/s and 6000 m/s respectively. A wavelet is a Ricker wavelet with the dominant frequency of 40 Hz and a frequency band of 5-75 Hz.
2) By giving a calculated depth of a target layer and an initial computational frequency and inputting a single-frequency common-shot gather and a single-frequency common-detector gather at the same time, computation is conducted to obtain a detector focusing result and a source point focusing result of the focus points, and the results are put at the source point positions and the detector positions respectively.
3) Through the formula 2 and the formula 3, computation is conducted on the source point focal-beam m gathers and the detector focal-beam gathers of all the points at the target layer so as to obtain a weighted focal-beam source point matrix and a weighted focal-beam detector focal-beam matrix respectively.
4) Through the formula 4, a normalized resolution function of one focus point is calculated, as shown in FIG. 3. The horizontal resolution and the definition are extracted through the resolution function, and then the performance of seismic imaging is quantified, in which the horizontal resolution is defined as a width of a main lobe corresponding to the position of 35% of a peak, value of a resolution function curve, and a corresponding definition is defined as a ratio of peak energy at this position to total energy. The peak energy is a square of a maximum amplitude value at the center; and as shown in FIG. 3, the ordinate is the amplitude, and the peak energy at this position is 1. Whereas the total energy is a sum of the squares of all amplitude values.
5) Through iteration of the formula 4, the horizontal resolutions and the definitions of all points in the model are calculated. Grey shades (i.e. a region A and a region B in the figure) shown in FIG. 4 are regions with high resolution and high definition.
6) For verification to display the seismic imaging performance of high resolution and high definition, two double-scatterer objects are added to the five-layer velocity model (FIG. 2), in which one double-scatterer object is in the high-resolution/definition region, and the other is out of the region. The depths of two double-scatterers are 300 m, each double-scatterer is formed by two scatterers with a distance of 20 m therebetween. FIG. 5 is a cross section of a prestack focal-beam migration image, in which two double-scatterer models are added. Dotted boxes on the two sides are enlarged imaging results of the two double-scatterer objects. It can be seen, relative to a low-resolution/definition region, the high-resolution/definition region has better resolution and makes better imaging. Therefore, focal-beam resolution analysis may serve as an auxiliary tool for evaluating the seismic imaging quality with a complex medium.

Three-dimensional seismic exploration is a major means for oil and gas exploration; and the underground structural features can be obtained only when processing data for seismic acquisition is imaged. Therefore, the selection of a seismic imaging technology/method is crucial to the imaging quality.

Prestack seismic migration imaging has already become a mainstream technology/method in the industry. However, for the reasons of limited-band data, limited imaging aperture, spatial sampling, complex structure and the like, prestack seismic migration imaging is limited to imaging resolution, and it is a challenging task of assessing the effect of a single factor on imaging. Existing resolution analysis with a point spread function and traditional focusing analysis are both based on response of a single-point scatterer, with ignoring the effect of surrounding points, and are generally applied to an acquisition observation system without being suitable for imaging data. In addition, for existing prestack seismic migration imaging, resolution analysis based on a wave equation is huge in computational cost and low in computational efficiency. Therefore, it requires a better auxiliary tool to measure the resolution performance for seismic imaging.

Aiming to the above problems, an objective of the present invention is to provide a seismic imaging resolution analysis method. Weighted focal-beam analysis is introduced into focal-beam migration, and focal-beam resolution analysis may be achieved with prestack seismic migration together without additional wavefield extrapolation, which may significantly lower the computational cost to develop practical resolution analysis for an imaging system with a complex medium. In the weighted focal-beam resolution analysis method of the present invention, detector focusing processing and source point focusing processing are conducted on the common-shot gathers and the common-detector gathers respectively; and the integral effects of a plurality of scatterers may be separated, and an Obtained focal-beam resolution function may be used for calculating a horizontal resolution and a definition of each focus point.

In the present invention, computer equipment may comprise a memory, a memory controller, one or more (only one is shown in the figure) processors and the like. Various components are electrically connected with each other directly or indirectly so as to achieve transmission or interaction of data. For example, these components may be electrically connected with each other through one or more communication buses or signal buses. The seismic imaging resolution analysis method comprises at least one software functional module which may be stored in the memory in a form of a software or a firmware, for example, a software functional module or a computer program comprised in a seismic imaging resolution analysis device. The memory may store various software programs and modules, for example, corresponding program instructions/modules of the seismic imaging resolution analysis method and device according to the embodiments of this application. The processor performs a variety of function applications and data processing by running the software programs and modules stored in the memory, that is, the parsing methods in the embodiments of this application are implemented.

1. A seismic imaging resolution analysis method, comprising:
configuring a processor to execute computer programs stored in a memory to perform the steps of the seismic imaging resolution analysis method by:
in the common-shot gathers, conducting detector focusing analysis on an focus point at (xⱼ, zₙ) in each source point gather to obtain a source point focal-beam gather;
conducting computation on a weighted source-focusing operator Pᵢₖ^{†} (zₙ, zₙ);
in the common-detector gathers, conducting source point focusing analysis on an focus point at (xⱼ, zₙ) in each source point gather to obtain a detector focal-beam gather;
conducting computation on a weighted detector-focusing operator Pᵢₖ^{†} (zₙ, zₙ); and
conducting computation on a normalized resolution function of a single focus point so as to obtain a horizontal resolution and a definition;
in which xⱼ represents the jₜₕ point on the abscissa, and zₙ represents a depth of a target reflector.

2. The method according to claim 1, wherein by giving zₙ and an initial computational frequency and inputting a single-frequency common-shot gather and a single-frequency common-detector gather at the same time, computation is conducted to obtain a detector focusing result and a source point focusing result of the focus points, and the results are put at the source point positions and the detector positions respectively.

3. The method according to claim 1, wherein the weighted source-focusing operator Pᵢₖ^{†} (zₙ, zₙ) is calculated through a formula 2, and the formula 2 is as follows: Pᵢₖ^{†} (zₙ, zₙ)=Fᵢ^{†} (zₙ, z₀)P(z₀, z₀)Fₖ(z₀,zₙ)+ε(z), (z≠zₙ); and
the weighted detector-focusing operator is calculated through a formula 3, and the formula 3 is as follows: Pᵢₖ(zₙ, zₙ)=Fₖ(zₙ,z₀)P(z₀,z₀)Fᵢ(z₀,zₙ)+ε(z), (z≠zₙ);
in which z₀ is a depth of a detector; P(z₀, z₀) represents information, received from the ground and reflected from a subsurface interface, of a wavefield; k locally varies at the periphery of a focus (xᵢ, zₙ); Fₖ(z₀, zₙ) and Fᵢ (z₀, zₙ) are detector-focusing operator at the depth zₙ; and Fₖ (zₙ, z₀) and Fᵢ (zₙ, z₀) are source-focusing operators at z₀.

4. The method according to claim 3, wherein the information, received from the ground and reflected from the subsurface interface, of the wavefield is as follows:
P(z₀,z₀)=D(z₀)Σₙ₌₁^{N}[W(z₀,zₙ)R(zₙ,zₙ)W(zₙ,z₀)]S(z₀),
D (z₀) is a detector matrix, S (z₀) is a source point matrix; W (z₀, zₙ) is an upgoing wave propagation matrix; W (zₙ, z₀) is a downgoing wave propagation matrix; and R (zₙ, zₙ) is a reflection coefficient matrix.

5. The method according to claim 4, wherein D (z₀) contains information, received by the detectors, of arrangement of seismic wavelets and detectors; S (z₀) contains arrangement information of source wavelets and a seismic source; for W (z₀, zₙ), in a uniform medium, each row is a discrete Green function matrix, representing that the wavefield is propagated from the depth zₙ to the depth z₀ upward; for W (zₙ, z₀), in the uniform medium, each column is a discrete Green function matrix, representing that the wavefield is propagated from the depth z₀ to the depth zₙ downward; and R (zₙ, zₙ) represents reflection and scattering relationships between a subsurface reflection point and an adjacent point.

6. The method according to claim 1, wherein a resolution function is calculated by a formula 4, and the formula 4 is as follows: Bᵢₖ(zₙ, zₙ)=\sqrt{Pᵢₖ(zₙ, zₙ)⊗Pᵢₖ^{†} (zₙ, zₙ)}, in which ⊗ represents multiplication of elements.

7. A seismic imaging resolution analysis device, comprising:
an obtaining unit for obtaining common-shot gathers and common-detector gathers;
a detector focusing analysis unit for, in the common-shot gathers, conducting detector focusing analysis on an focus point at (xⱼ, zₙ) in each source point gather to obtain a source point focal-beam gather;
a source-focusing operator weight computation section for conducting computation on a weighted source-focusing operator Pᵢₖ^{†} (zₙ, zₙ);
a source point focusing analysis unit for, in the common-detector gathers, conducting source point focusing analysis on an focus point at (xⱼ, zₙ) in each source point gather to obtain a detector focal-beam gather;
a detector-focusing operator weight computation section for conducting computation on a weighted detector-focusing operator Pᵢₖ (zₙ, zₙ); and
a computation and analysis unit for conducting computation on a normalized resolution function of a single focus point so as to obtain a horizontal resolution and definition;
in which xⱼ represents the jₜₕ point on the abscissa, and zₙ represents a depth of a target reflector.

8. (canceled)

9. A computer-readable storage medium, wherein computer programs are stored thereon; and when the computer programs are executed by a processor, steps in the method according to claim 1 is performed.
